(19) United States
(12) Patent Application Publication
(10) Pub. No.: US 2012/0105730 A1
(43) Pub. Date: May 3, 2012

(54) SYSTEM AND METHOD FOR MOBILE COMPUTING TRANSMISSION ON A NETWORK OF DATA ASSOCIATED WITH A TELEVISION DISPLAY

(76) Inventors: Israel Eliezerov, Ramat Gan (IL); Yaniv Romem, Jerusalem (IL); Zeev Braude, Ramat Gan (IL)

(21) Appl. No.: 13/381,378

(22) PCT Filed: Nov. 7, 2010
(86) PCT No.: PCT/IL10/00918

§ 371 Date: Dec. 29, 2011

Related U.S. Application Data
(60) Provisional application No. 61/280,501, filed on Nov. 5, 2009.

(51) Int. Cl. H04N 5/38

(52) U.S. Cl. 348/723; 348/E05.093

(57) ABSTRACT

A system and method for transmitting over a cellular network television program information to a mobile device, wirelessly transmitting television commands from the mobile device to a television, transmitting from the device over the cellular network television viewing information of what program is being displayed on the television at any particular moment, and transmitting to and from the mobile device over the cellular network any of data, video, text or other information relating to the program then being displayed on the television.

### FIELD OF THE INVENTION

The present invention relates to remote control of a device such as television by a mobile computing device that exchanges display data with a network.

### BACKGROUND OF THE INVENTION

Applications are available for remote control of a display or media device such as a television from a mobile computing device. Applications are also available for downloading television programming schedules from a network to a mobile computing device. Numerous television programs such as infomercials and advertisements include messages seeking to convince a viewer to make a phone call to purchase a product or contact a supplier of goods or services or take other action during the course of a viewing or display of a program on television.

### SUMMARY OF THE INVENTION

Some embodiments of the invention may include a method of transmitting data associated with a television program, where the method may include transmitting, over a wireless network such as a cellular network, television program schedule data to a mobile computing device such as a cellular telephone, and having the mobile device transmit, wirelessly control commands to a television to control a display on the television of a program about which data had been included in the television program schedule data. The method may include transmitting, over the wireless network, from the mobile computing device, data regarding the display of the program on the television, where such data may include for example the identity of the program then being displayed on the television. The method may include receiving by the mobile computing device from the wireless network advertising data that is associated with the display of the program on said television, where such advertising data may include for example, data such a phone number or other details that were not included in the program then being displayed on the television.

In some embodiments, a method may include transmitting to the mobile computing device a text message from a second mobile computing device, where the text message contains information regarding the program then or currently displayed on the television.

In some embodiments, a method may include transmitting to the mobile computing device both a text message and a segment of the program displayed on the television.

In some embodiments, a method may include storing data regarding the display or viewing habits, and transmitting to the television a second program associated with the advertising data.

In some embodiments, a method may include blocking from the mobile computing device the transmission of data regarding said the program being displayed on the television

In some embodiments, a method may include prompting the mobile computing device to execute a call to a telephone number included in the advertising data.

In some embodiments, a method may include transmitting over the wireless network to the mobile computing device image data associated with the display of the program on the television, such as a further image of a product that may appear in a program being displayed on the television.

In some embodiments, a method may include transmitting a viewer response to an inquiry regarding display of said program on said television.

Some embodiments of the invention may include a system for transmission of current television viewing data, such as the identity or other information relating to a program then being displayed on the television, where such system includes a mobile computing device, having a cellular network transmitter and having a short distance signal transmitter that may transmit television control commands from the device to a television. A system may also include a television control command receiver associated with the television that may implementing the television control command signals on the television control commands. A system may also include a server to receive information from the mobile device over the cellular network, where such information indicates what is currently being displayed on the television, and to transmit to the mobile device data such as advertising or other commercial data associated with the current display of the television.

In some embodiments the mobile device may receive contact data in the form of a telephone number prompt, URL data or other data which may be executed by mobile device to contact or call over the cellular network, a party associated with the advertising data.

In some embodiments, the mobile device may receive and send over the cellular network to a second mobile device, data such as text messages, voice messages or image data associated with the program currently displayed, where the second mobile device had also transmitted television command control data to a second television, and the second television currently displays the program being displayed by the first television.

In some embodiments a server may store a record of the television control commands issued by the mobile computing device and a record of the current display of the television.

In some embodiments, the mobile device may block a transmission over the cellular network of information regarding the program control commands that were issued from the device or regarding a display of a program on the television.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is schematic diagram of components of a system in accordance with an embodiment of the invention; and

FIG. 2 is a flow diagram of a method in accordance with an embodiment of the invention.

### DETAILED DESCRIPTION OF THE PREFERRED EMBODIMENTS

In the following description, various embodiments of the invention will be described. For purposes of explanation, specific examples are set forth in order to provide a thorough understanding of at least one embodiment of the invention. However, it will also be apparent to one skilled in the art that other embodiments of the invention are not limited to the examples described herein. Furthermore, well-known features may be omitted or simplified in order not to obscure embodiments of the invention described herein.

Unless specifically stated otherwise, as apparent from the following discussions, it is appreciated that throughout the specification, discussions utilizing terms such as “selecting,” “evaluating,” “processing,” “computing,” “calculating,” “associating,” “determining,” “designating,” “allocating” or the like, refer to the actions and/or processes of a computer, computer processor or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The processes and functions presented herein are not inherently related to any particular computer, network or other apparatus. Embodiments of the invention described herein are not described with reference to any particular programming language, machine code, etc. It will be appreciated that a variety of programming languages, network systems, protocols or hardware configurations may be used to implement the teachings of the embodiments of the invention as described herein. In some embodiments, one or more methods of embodiments of the invention may be stored on an article such as a memory device, where such instructions upon execution by a processor result in a method of an embodiment of the invention on one or more devices associated with the processor, such as a server, mass data storage, display or other electronic device.

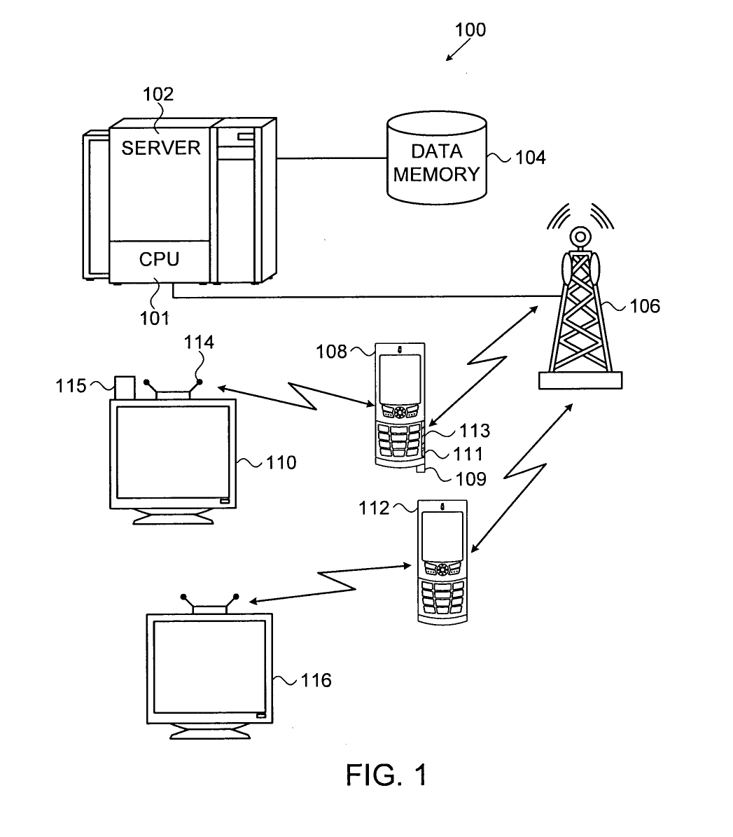

Reference is made to FIG. 1, a system in accordance with an embodiment of the invention. In some embodiments, system 100 may include a server 102 having a processor 101 such as a central processing unit and a memory 104 that are associated with a cellular network 106 or other long distance wireless network such as for example WiFi, whether directly or through other paths of connectivity that may rely on a combination of wired and wireless links. Cellular network 106 may broadcast or transmit to and receive signals from, a mobile computing device 108 such as a cellular telephone, smartphone, iPhone™ telephone, Android™ telephone or other device that has computing capability, data storage capacity, display functionality, data input functionality and cellular connectivity. Device 108 may include a processor 111 and a memory 113 or have attached to it a device 109 providing signal transmission capability for short distance communication such as for example Infra Red signals, to Bluetooth™ or other short distance wireless communication formats that may broadcast signals carrying data over a short distance. Device 108 may establish and maintain such short distance communication with a television 110 display or other display (e.g., a monitor) that may be equipped with a receiver/transmitter 115 for receiving and transmitting signals to and from device 108.

In operation, television programming data, such as an electronic programming guide (EPG) may be transmitted over cellular network to device 108. Such programming data may be translated from server 102 and displayed in a format suitable for display on device 108, such as in the form of a table, chart or calendar having entries corresponding to television programs, where some or all of such entries may be selected by a user of device 108. A display on device 108 may also include other controls of television 110 or other video display devices such as volume, channel selection and other functions that may typically be found on a television remote control. A selection of a program for display on the television may be transmitted wirelessly from device 108 to television 110, and the television may display the requested program. Device 108 may store or track data in real time regarding the program being viewed or displayed on television 110, such as which program is being viewed, for how long the program has been displayed on television 110, and other viewing data relating to the current or past viewing or display on television 110. At certain intervals, device 108 may transmit data over wireless network 106, indicating or describing for example the program then being displayed on television 110. Server 102 or another device may transmit data over cellular network 106 to device 108, where such data is associated with the program then being watched. For example, if the program then being watched (in real time) is a commercial advertisement, server 102 may transmit to device 108, telephone number data that is related to the advertisement then being displayed on television 110, such as a telephone number of the advertiser or supplier. The transmitted number or other telephone information may serve as a prompt that allows device 108 to call the number, access a web site or otherwise establish a contact by for example a one-click action by a user, with an advertiser or other entity associated with a program being displayed on the television. In some embodiments, advertising data that is transmitted to the mobile computing device may be further or additional information about a program such as an advertisement that was or is then being displayed on the television. For example, advertising data may include specifications about a product or service that is shown on a program being displayed on a television, or how to receive or order such product or service In this way, device 108 affords the advertiser transmission of one-click dialing capability at the same time that the advertisement for the advertiser is being displayed on television 110, thereby synchronizing the advertising or information transmitted to device 108 with the advertising then being displayed on television 110.

More generally, device 108 may synchronize a function of a telephone, smart phone and television remote control with the program or advertisement then being watched on the television, and allow real time interaction by way of cellular network 106 to and from user by way of device 108, with prompts that are delivered to device 108 to match the program then displayed on television 110. For example, if a user is watching a quiz show, server 102 may transmit to device 108 a screen allowing the user to play the quiz show from device 108, where his responses to the quiz show he is viewing on television 110 are transmitted in real time over cellular network 106 to server 102, where his performance can be evaluated and/or shared with others, also in real time.

In some embodiments, prompting or delivering a prompt may include delivering a URL, phone number or other data that may allow a user to readily, such as with one or more clicks on the mobile device, to gain access to or contact a particular party or entity that is associated with the advertising data. Server 102, memory 104 or some other device may store data regarding or describing the programming viewing history or habits that are relayed or transmitted over cellular network 106 from device 108. Device 108 may also send and receive messages that are transmitted over cellular network 106, such as text, voice and/or video clips from other mobile devices 112, as may be held by other users who may also be viewers of the same program. Such text or voice capability may allow real-time social networks to be established by those watching a particular program, and allow Twitter, Facebook and other chat or talk back streams to develop or be conducted in the course of viewing a program. In some embodiments, data may be transmitted to device 108 indicating a number or percentage of households that are then currently watching a particular program, and may allow a user to vote on or transmit his own feelings about a program to the broadcaster while the program is being aired.

In some embodiments, server 102, memory 104 or some other device may select and issue a signal to a server that may be associated with the television broadcast, to deliver a particular program, such as a commercial advertisement to television 110, where such particular program is associated with a past purchase or preference that had been transmitted from device 108.

In some embodiments, television 110 may be equipped with a set-top box 114 that may also include a processor and a memory such as cable and satellite set-top boxes, that may receive short distance signals from device 110 and may transmit to device 108, data on the program being displayed. Box 114 may also control one or more of the channel selection function, volume, scan, on/off and other functions that may be associated with television 110.

In some embodiments, EPGs may be available from one or more servers that are associated with a network such as the Internet, and these EPGs may be available from a browser that may run on device 108. Device 108 may translate an EPG into a format that may be transmitted from for example an audio outlet (ear plug jack) of device 108 into which may be fitted an IR device transmitter. Data in an EPG may be translated into channel or channel control data recognizable by for example set-top box 114. In some embodiments, a user may pre-set programs into device 108, and transmit such pre-set commands to television 110 at a later time, when device may be in transmission range of television 110.

EPG information is optionally presented to the end-user on the basis of channels and shows. There is optionally no presentation of channel numbers to end-users. Instead, end-users can optionally interact only with the content itself. End-users can optionally choose their desired viewing content, and optionally choose to have the remote automatically present that content (e.g. “auto-zap”) when it is available. Other content can optionally be marked as uninteresting and subsequently not shown. Interesting and uninteresting markings can optionally be done both on a channel basis and on a show basis.

In some embodiments, a memory such as memory 104 or memory 111, may to store records of past interactions between a user of television 110 by way of device 108, or to store actions taken through or with device 108 to purchase or contact phone numbers transmitted to device 108 by server 102 or through system 100. For example, a record may be kept of pizza orders that were executed in the past by device 108 from prompts supplied to device 108 during a football program. A processor 101 may customize the data sent to device 108 during future programs, such as by displaying pizza advertising data when football programs are being displayed on the television, and transmitting to device 108 prompts for ordering pizza during or after a display of such pizza advertising information. For example, memory 104 may store a record in a centralized location and such record may be used to determine viewing and purchasing preferences of a user of device 108 with television 110. For example, a record may include viewing and ‘channel surfing’ (frequency of changing channels) habits of a user, may include time and duration of viewing, favorite programs, programs watched, and other information typically collected by television rating services. Such information may be available in real time or near real time as device 108 may transmit viewing data to server 102 while the viewer is still watching.

In some embodiments, device 108 may receive and present to a user a display of an EPG, as may be downloaded directly from a data base associated with a network device, and as may be formatted or translated to add control data that may be transmitted by device 108 to box 114 as television control instructions. In some embodiments, the downloaded EPG may include advertisements, video clips or other promotions that may be related to a particular program, event, product or service. For example, a promotion sent during a program's airing on broadcast television, may alert a user of device 108 to the action or progress of another program that he may not be watching at the time. Device 108 may serve as an alert to an event on another channel and may allow a user to program an automatic change of a channel upon the receipt of such an alert. Such an alert may be set to indicate for example a home run or other action in a sport event, a speech or and end of a game show, where the alert to such event may be transmitted over cellular network 106 to device 108, and device 108 may automatically and in real time issue a control command to switch a channel on television 110 to display the event. Alerts, advertisements or promotions may be transmitted to device 108 based on past actions or commands issued by a user of to device 108. For example, if stored control commands that were issued by device 108 indicate that the user frequently views a last few minutes of a particular game show, an alert or promotional message may be transmitted to device 108 offering a user an automatic or simplified (one-click) way to change or record the event.

In some embodiments, the EPG may be searchable or scrollable on device 108, and may be downloaded or inserted into for example an XML format that may run on device 108.

In some embodiments of the invention mechanisms are available to ensure that the end-user can optionally protect their privacy as they see fit, including blocking or preventing transmission of all private information, such as what program a viewer is watching at any time or what prompted phone call a user is making.

Server 102 is optionally a dynamically scalable set of servers hosted with a hosted service provider. In some embodiments of the invention, the Internet-based servers run the commonly used LAMP suite for Internet server applications, e.g. the Linux operating system, the MySQL database, the Apache web server and the PHP scripting language.

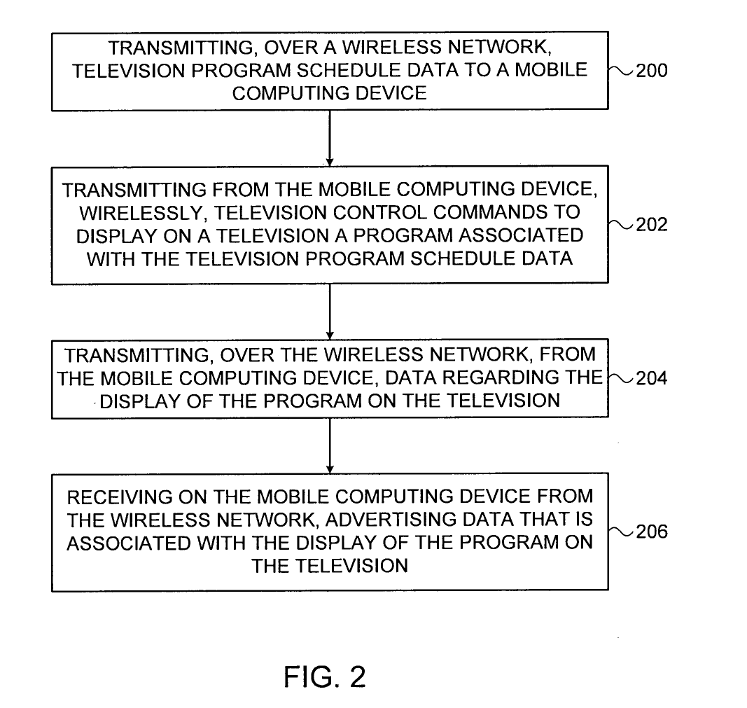

Reference is made to FIG. 2, a flow diagram of a method of transmitting data associated with a currently displayed television program, in accordance with an embodiment of the invention. In block 200 a server or other device may transmit, over a wireless network, television program schedule data to a mobile computing device. In block 202 the mobile computing device may transmit wirelessly television control commands that may a display on a television of a program associated with the television program schedule data, such as a program that was listed or included on the EPG. In block 204 the mobile computing device may transmit, over the wireless network, data regarding the display of the program on the television, such as identification data of a program then being displayed on the television. In block 206 the mobile computing device may receive a signal over the wireless network, that includes advertising data that may be associated with the then currently displayed program on the television.

In some embodiments, a second mobile device 112 that had transmitted data to a second television 116 relating to the program then being currently displayed on the second television may transmit text or voice messages to the first mobile device, where such text or voice messages are related to the program then being currently displayed on the first television and the second television.

In some embodiments, a server may transmit over a network to the cellular network and further to the mobile device, an image or segment of a television program that can be viewed on television, and the segment of the program may be displayed on the mobile device at a particular time relative to when the program is to be aired, and as a promotional message to encourage a user to view the program.

In some embodiments, a server may transmit over a network to the cellular network and further to the mobile device, a second program such as a continuation of a commercial advertisement, that is associated with a first program such as a first part of the advertisement or part of a television program, where the first program is at such time or other particular time being displayed on the television, and the second program is transmitted for display on the mobile device. For example, a first part of a commercial may be aired on television, and a second part of a commercial having further details, may be transmitted to a mobile device for further viewing.

In some embodiments, a mobile device may be equipped or suitable to selectively block of transmission of viewing data from being transmitted back over the cellular network to a server.

In some embodiments the mobile computing device may receive data that may serve as a prompt for a call to be made to a telephone number that is displayed on the mobile device, where the call may be initiated by a one click or single action or set of actions introduced on the mobile device.

In some embodiments, a method may include translating the television program schedule data for transmission over a short-distance wireless link from the mobile computing device to the television.

Some embodiments of the invention may include a system for transmission of a current or real time television viewing data, such as data on what is being displayed on a television, where the system includes a mobile computing device that has a cellular transmitter, a short-distance signal transmitter that may transmit television control commands from the mobile device to a television, and a television control command receiver 115 that may receive short-distance, wireless commands from the mobile device and implement the commands on a television. The system may further include a server to receive data or information from the mobile device over the cellular network, where such information includes what is then being currently displayed on the television; and where the server may transmit to the mobile device other data that is associated with or relevant to the program then being displayed on the television.

In some embodiments, the mobile device may display the data that is associated with the program then being displayed on the television, where such data includes a prompt for a call from the mobile device over the cellular network.

In some embodiments two mobile devices that have both issued television control commands to two different televisions, where the commands are to display the same program on the two different televisions, may also send data such as text, voice or image data between and among such two mobile devices, where the data relates to the program then currently being displayed on such two different televisions. In some embodiments, the mobile devices may issue signals over the cellular network to locate or identify other mobile devices that have also issued commands to other televisions to display a then currently broadcast program on their respectively associated televisions.

In some embodiments, a server may store records relating to the television control commands that were issued by the mobile device relating to the display of programs by a television, and may store a record of phone calls made from the mobile device over a wireless network during a display of such programs.

Some embodiments of the invention may be implemented, for example, using a machine-readable medium such as for example a memory circuit and/or an article which may store an instruction and/or a set of instructions that, when executed by a machine, cause the machine to perform a method and/or operations in accordance with embodiments of the invention. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, assembly language, machine code, or the like.

It will be appreciated by persons skilled in the art that embodiments of the invention are not limited by what has been particularly shown and described hereinabove. Rather the scope of at least one embodiment of the invention is defined by the claims below.

We claim:

1. A method of transmitting data associated with a television program, comprising:
transmitting, over a wireless network, television program schedule data to a first mobile computing device, wherein said first mobile computing device is to transmit, wirelessly to a television, a plurality of control commands to said television, a command of said plurality of control commands to control a display on said television of a program associated with said television program schedule data;
transmitting, over said wireless network, from said first mobile computing device, data regarding said display of said program on said television; and
receiving over said first wireless network by said first mobile computing device advertising data associated with said display of said program on said television.

2. The method as in claim 1, comprising transmitting to said first mobile computing device a text message from a second mobile computing device containing information regarding said display of said program on said television.

3. The method as in claim 2, comprising transmitting to said first mobile computing device said text message and a segment of said display of said program on said television.

4. The method as in claim 1, wherein said display of said program on said television comprises a first program, and comprising storing said data regarding said display of said program on said television, and transmitting to said television a second program associated with said advertising data.

5. The method as in claim 1, comprising blocking said transmitting, over said wireless network, from said mobile computing device, said data regarding said display of said program on said television

6. The method as in claim 1, comprising prompting said first mobile computing device for a call from said first mobile computing device to a telephone number included in said advertising data.

7. The method as in claim 1, comprising transmitting over said wireless network to said first mobile computing device image data associated with said display of said program on said television.

8. The method as in claim 1, wherein said transmitting, over said first wireless network, from said first mobile computing device, data regarding said display of said program on said television, comprises transmitting a viewer response to an inquiry regarding display of said program on said television.

9. The method as in claim 1, wherein said transmitting, over a wireless network, television program schedule data, comprises transmitting over a cellular network said television program schedule data.

10. A system for transmission of current television viewing data, comprising:
a mobile computing device, said device including a cellular network transmitter, and a short distance signal transmitter to transmit television control commands from said mobile device to a television;
a television control command receiver suitable for implementing on said television said television control commands transmitted from said mobile device by said short distance signal transmitter;
a server to receive information from said mobile device over said cellular network, said information indicating a current display of said television;
and to transmit to said mobile device data associated with said current display of said television.

11. The system as in claim 10, wherein said mobile device is to display said data associated with said current display of said television as a prompt for a call from said mobile device over said cellular network.

12. The system as in claim 10, wherein said mobile device comprises a first device and wherein said television comprises a first television, and wherein said first device is to receive and send over said cellular network data associated with said current display to a second mobile device, said second mobile device having transmitted said television control signal to a second television, said second television having said current display.

13. The system as in claim 10, wherein said data comprises image data associated with said current display.

14. The system as in claim 10, wherein said server is to store a record of said television control commands and of said current display of said television.

15. The system as in claim 10, wherein said mobile device is to block a transmission of said information from said mobile device over said cellular network.

16. An article having stored thereon instructions that when executed by a processor result in:
transmitting, over a wireless network, television program schedule data to a first mobile computing device, wherein said first mobile computing device is to transmit, wirelessly to a television, a plurality of control commands to said television, a command of said plurality of control commands to control a display on said television of a program associated with said television program schedule data;
transmitting, over said wireless network, from said first mobile computing device, data regarding said display of said program on said television; and
receiving over said first wireless network by said first mobile computing device advertising data associated with said display of said program on said television.

17. The article as in claim 16, where upon said execution, said instructions further result in transmitting image data from said server to said mobile device over said cellular network, said image data associated with said display of said program on said television.

18. The article as in claim 15, where upon said execution, said server prompts telephone dialing data on said mobile device.
